(19) United States
(12) Patent Application Publication
(10) Pub. No.: US 2006/0052167 A1
(43) Pub. Date: Mar. 9, 2006

(54) Mobile entertainment system and method

(76) Inventors: Michael Lehmann Boddicker, Encino, CA (US); Lou Woolf, Sherman Oaks, CA (US); Keith Heavenridge, Encino, CA (US)

Correspondence Address: Marshall E. Rosenberg, Esq., P.O. Box 966, Woodland Hills, CA, 91365-0966, US

(21) Appl. No.: 11/054,647

(22) Filed: Feb. 9, 2005

Related U.S. Application Data
(63) Continuation-in-part of application No. 10/933,759, filed on Sep. 3, 2004.

(51) Int. Cl. A63F 13/00

(52) U.S. Cl. 463/37

(57) ABSTRACT

A system of and method for installation and use thereof that provides for application of karaoke system components applicable mobile environments, including integrated or retrofittable components in a manner that allows vehicle occupants to selectively utilize in combination a karaoke system together with audio and related operating systems to provide an integrated karaoke system.

### CROSS-REFERENCE TO RELATED APPLICATIONS

This is a continuation-in-part of application Ser. No. 10/933,759, filed Sep. 03, 2004.

### STATEMENT RE: FEDERALLY SPONSORED RESEARCH/DEVELOPMENT

Not applicable

### REFERENCE TO MICROFICHE APPENDIX

Not applicable

### BACKGROUND OF THE INVENTION

1. Field of the Invention

The present invention relates to entertainment systems, and more particularly, to entertainment systems for either stationary or mobile use (i.e. in motor vehicles), either as an integral system or for modular application as a retrofit, and for the latter case utilizing in situ vehicle components to support and broadcast one or more sound streams, or at or adjacent a desk top or other location.

2. Description of the Related Art

Karaoke is an increasingly popular form of entertainment which allows enables live participation, to sing along with a desired soundtrack of a virtually unlimited spectrum of songs. Originally conceived in Japan, karaoke is widely enjoyed throughout the U.S. and the world, in private homes as well as in clubs and restaurants. Karaoke is a Japanese abbreviated compound word which translates roughly as “empty orchestra.” “Kara” comes from “karappo” meaning empty, and “oke” is the abbreviation of “okesutura,” or orchestra. Karaoke is used to describe any sing-a-long track which may optionally be displayed on a TV or video screen. Usually, a music recording consists of vocals and accompaniment. Those music recordings in which only the accompaniment is recorded are called karaoke CD's or karaoke discs.”

Karaoke systems are known. For example, U.S. Pat. Nos. 5,250,747; 5,454,723; 5,473,106; 5,484,291; 5,518,408; 5,609,486; 5,679,911; 5,684,261; 5,739,452; and 5,811,708 all describe karaoke-directed systems which generally allow separate input streams of one or more voices, together with a music soundtrack to be amplified, adjusted and mixed together and outputted to an audio speaker for broadcasting to an audience. U.S. Pat. No. 5,713,633 describes a chamber in a backrest assembly that may receive and support a karaoke system. U.S. Pat. No. 4,866,515 describes an individual entertainment system installed in each seat back of an airplane with entertainment signals transmitted from a central unit to each individual entertainment system.

It will be appreciated that such prior art apparatuses are generally available in two formats: portable and component style. A prior art portable player, typically available as an “all-in-one player” commonly includes a music soundtrack player in one or more formats including cassette and CD, one or more inputs for a like number of microphones (for solo or duet singing as desired), and a built-in speaker for outputting the combined sound stream. Some prior art karaoke players may also include a recording device to capture the output, pitch controller, reverb controller, and audio output jacks.

Alternatively, component-style prior art apparatuses component karaoke players are similar to CD players in size and function except that they have several additional features: two or more microphone inputs with separate microphone volume controls and a digital key and digital echo control. The component player does not have its own speaker or amp so it must be connected to a home or professional sound system to drive the sound. Similar to portable karaoke players, the component player has a video output jack for connection to a home TV or to a professional monitor. The typical karaoke component player does not have its own audio recorder so any tapes/CDs must be made using a separate tape recorder.

The component players are typically multi-disc systems, either carousel or drawer. The component system also has many programmable features that make it easy to cue specific discs and tracks, which are features considered important by professional karaoke “jockeys”.

Despite the prior art described above, however, there are additional locals and venues where the inventors of the present invention have determined there is a desire to utilize the karaoke concept, including mobile applications. There is known in the prior art a car-mounted audio system wherein the parts which an operator needs for operation of the system i.e., the operator controls such as knobs and buttons, the display section for displaying operational states, and the drive deck (the mechanical components), are provided in a console unit or in the dashboard, and the other parts are provided in hidden-away locations as much as possible. This arrangement provides the freedom of combining each of the units with other units and it is contemplated that various different types of components, e.g., personal radio communication devices, compact disk units and so, can be combined to expand the system as desired. See FIG. 10, showing certain prior art structure. In particular, in FIG. 10, the components shown in double-line enclosures are provided in the console or dashboard unit, which comprises operator control section 16, display section 17, and a deck section 18. The parts shown in single-line enclosures are provided in hideaway locations. The latter include a tuner unit 19, a preamplifier unit 23, a unit 24 for singing an accompaniment to the tune of a melody recorded on a recording medium such as magnetic tape or other recorded media (hereinafter referred to as “the karaoke unit” or “the karaoke apparatus”), a graphic equalizer unit 25, an ASL unit 26 (an apparatus to control the volume automatically), and a power amplifier unit 27. These components comprise the audio signal processing portion of the system.

The units are connected to one another by a connecting cable 20. The cable 20 is composed of a microcomputer bus line 21 and a two-core shielding connection line 22 which comprises an L & R channel line and a ground line. Microcomputer 1 and a plurality of microcomputers 2 are respectively connected via the microcomputer bus line 21, wherein the microcomputer 1 works as a master source and each microcomputer 2 works as a terminal satisfying its unit specification.

Each of the microcomputers 1 and 2 are connected with the circuits 4 to 11 within the units 16-26. When the circuits 4, 5 of the operator control section and the display section do not have any signal sources, then they would not be connected with the audio bus line 22.

A microphone 12 for the karaoke apparatus is connected with the circuits 9 of the karaoke unit 24. A microphone 13 for detecting white or pink noise (i.e. ambient characteristics) is connected with the circuit 10 of the graphic equalizer 25. Further, a microphone 14 for detecting any running or ambient noise is connected with the circuit 11 of the ASL unit 26. In addition, speakers 15 for the L & R channel are connected with the power amplifier units 27. When the operator manipulates the operator controls in this prior art audio equipment, each unit is controlled by the microcomputer 1 and a result of the control state is displayed on the display 17. During operation of deck 18, an audio signal from the circuit 6 is fed to the audio source bus line 22 shown by the dotted line in FIG. 1 and is fed to the circuit 8 of the preamplifier unit 23, wherein signal processing to effect volume control and tone control is performed. The processed signal is fed to the audio signal line 28, which is connected with the power source. Therefore, conventional audio processing is done toward said signal so that finally the speaker 15 is driven through the power amplifier 27.

In the case of the karaoke operation, the audio signal is detected through the microphone 12 connected with the circuit 9 of the karaoke unit 24. This detected signal is subjected to echo processing and mixing and fed to the audio signal line 28. The microphone 13 connected with the graphic equalizer 25 is used for controlling the automatic frequency characteristic and detects the pink noise transmitted inside the car. That is to say, the pink noise originated at the circuit 10 is amplified through the power amplifier and put on the air over the speaker 15 in the car. Owing to the fact that the microphone 13 then detects the sounded pink noise, the circuit 10 discriminates the level at each frequency processed by the graphic equalizer and controls the equalizer so as to produce a flat frequency characteristic. Since the microphone 14 of the ASL unit 26 detects the running noise inside the car, the circuit 11 controls the volume and the tone, etc., on the base of the noise for compensating the Masking Phenomenon which is brought by the running noise. Audio signal system processing of the prior art includes audio outputs of the sources, i.e., the deck section, the tuner unit and other source units, are connected to the audio source bus line as the current source through a voltage-current conversion circuit 29. The signal currents from the plural sources are fed to a current-voltage conversion circuit 30 of the preamplifier 23 to convert the currents into voltage, which are fed to another audio unit through the volume tone circuit 31. Since the car-mounted audio equipment of the prior art is configured as mentioned above, separate microphones have to be provided for the karaoke unit 24, the graphic equalizer unit 25, and the ASL unit 26.

However, none of the known prior art of record is adaptable for use with control or non-control surfaces of the motor vehicle to which the equipment is mounted for use. In particular, the prior art fails to provide for application of karaoke system components applicable either as built-in (i.e. integrated) or retrofittable components in a manner that allows the vehicles's occupants to selectively utilize in combination a karaoke system together with audio and related vehicular operating systems to provide an integrated karaoke system.

Accordingly, there exists a need for a system of method of installation and use thereof that provides for application of karaoke system components applicable either as built-in (i.e. integrated) or retrofittable components in a manner that allows the vehicles's occupants to selectively utilize in combination a karaoke system together with audio and related vehicular operating systems to provide an integrated karaoke system.

### OBJECTS AND SUMMARY OF THE INVENTION

Accordingly, it is an object of the invention to provide a novel entertainment system for a motor vehicle.

It is another object of the invention to provide a novel entertainment system that is integrated into the stereo system of a motor vehicle.

It is a still further object of the invention to provide a novel entertainment system that may be retrofitted and integrated into the radio system of the vehicle, whereby the components of the entertainment system are selectively integrated into control or noncontrol units and surfaces of the vehicle.

It is yet another object of the invention to provide a novel entertainment system of the invention that is integrated into a unit for installation into a vehicle when it is being assembled.

It is yet a further object of the invention to provide a novel input device for use in connection with an audio system, whether mobile or fixed within a mobile vehicle or for fixed land application, the novel input device providing karaoke-style user participation in connection with an audio stream produced by the audio system.

According to the present invention, a system of and method for installation and use thereof that provides for application of karaoke system components applicable either as built-in (i.e. integrated) or retrofittable components in a manner that allows the vehicles's occupants to selectively utilize in combination a karaoke system together with audio and related vehicular operating systems to provide an integrated karaoke system. These objects and other objects which will become apparent from the following specification are provided by an entertainment system for a motor vehicle which comprises a radio or other source of downloadable music data, a source of recorded music connected thereto, at least one loudspeaker, and at least one transducer arranged to receive the voice of an occupant of the vehicle and to produce an electronic signal output, and an electronic circuit for receiving said signal and for coupling the signal output to said radio. Operation of the system is provided by input to input devices such as but not limited to impact pads adapted to be fitted to a variety of surfaces of the motor vehicle, such as the steering wheel, dashboard, seat back, console, other interior panels, as well as operating controls such as but not limited to levers, switches, and other controls. It will be appreciated that operation of the system is not limited to the interior of the vehicle, but may be extended to adjacent areas such as a pick-up bed, trunk or even external surfaces of the vehicle designated for use in conjunction with the system.

### BRIEF DESCRIPTION OF THE DRAWINGS

FIG. 1 is a diagrammatic view of the entertainment system of the present invention mounted to a mobile environment, such as an automobile.

FIG. 2 is a front elevational view of operative aspects of the present invention mounted adjacent to a steering wheel of an automobile.

FIG. 3 is a partial, detailed view of the components and mounting structure shown in FIG. 2.

FIG. 4 is a cross-sectional view of the percussion components shown in FIGS. 2 and 3, further showing mounting structure for mounting the percussion components to a steering wheel of an automobile.

FIG. 5 is a perspective view of an alternate embodiment of one aspect of the invention, in which the percussion and optionally various karaoke system components are mounted to and supported by a cantilever arm secured to a structure of the automobile in which the system is installed.

FIG. 6 is a perspective view of the karaoke system housing.

FIG. 7 is a front elevational view of an in-dash head unit for the karaoke/entertainment system supported by the automobile.

FIG. 8 is a diagrammatic view of the karaoke/entertainment system of the present invention, showing input and output elements together with operational circuitry.

FIG. 9 is a diagrammatic view of the karaoke/entertainment system of the present invention, showing additional input and output elements together with operational circuitry desired to provide a desired conditioned output audio signal as well as visual indicators thereof.

FIG. 10 is a diagrammatic view of an entertainment system of the prior art, showing common operational elements.

FIG. 11 is an elevational view of a motor vehicle steering wheel to which the entertainment system of the present invention is installed.

FIG. 12 is a sectional view of the motor vehicle steering wheel of FIG. 11, showing additional aspects of the invention.

FIG. 13 is a cross-sectional view taken through section 13-13 of FIG. 12, showing additional aspects of the invention.

### DETAILED DESCRIPTION OF THE PREFERRED EMBODIMENTS

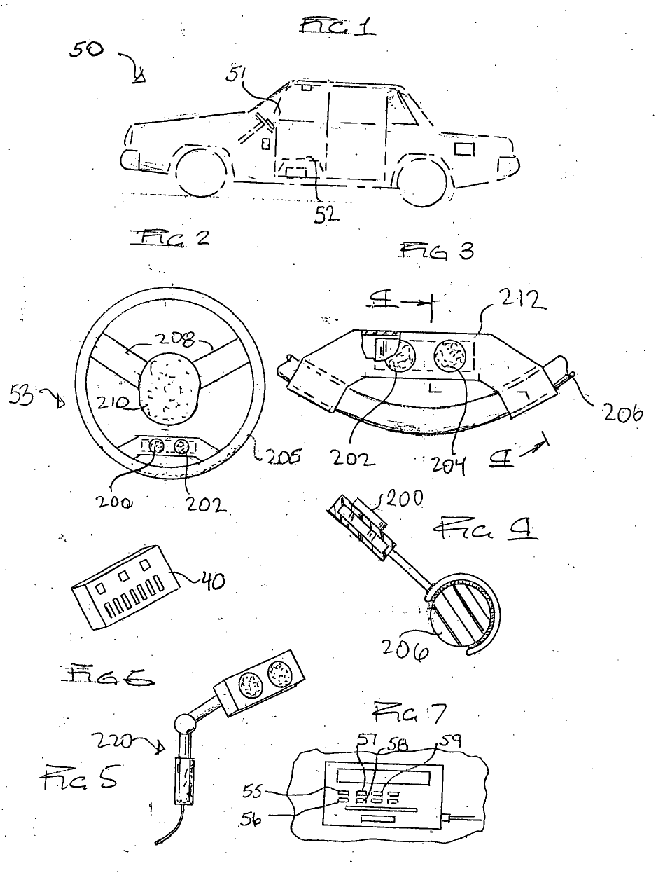

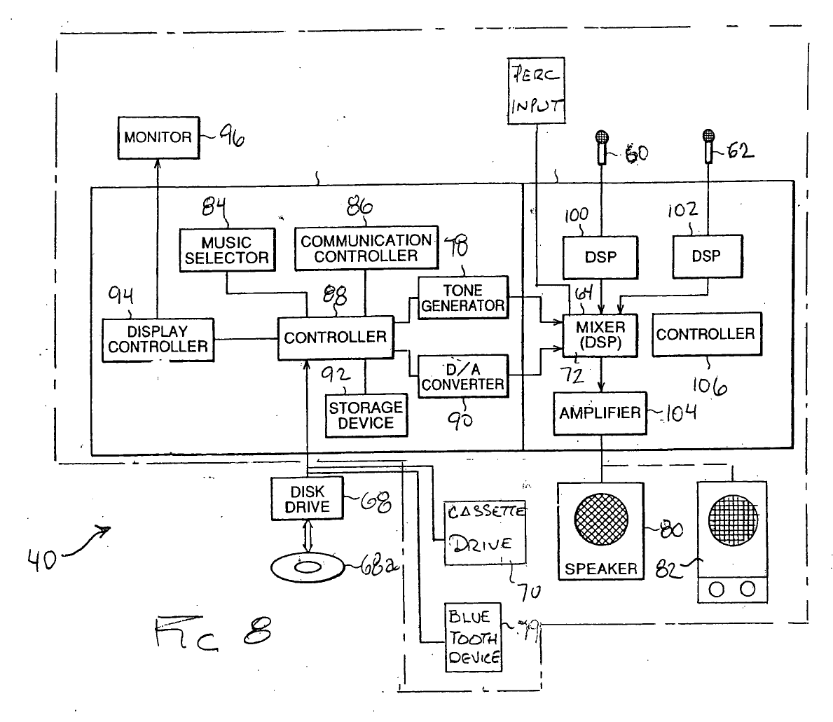

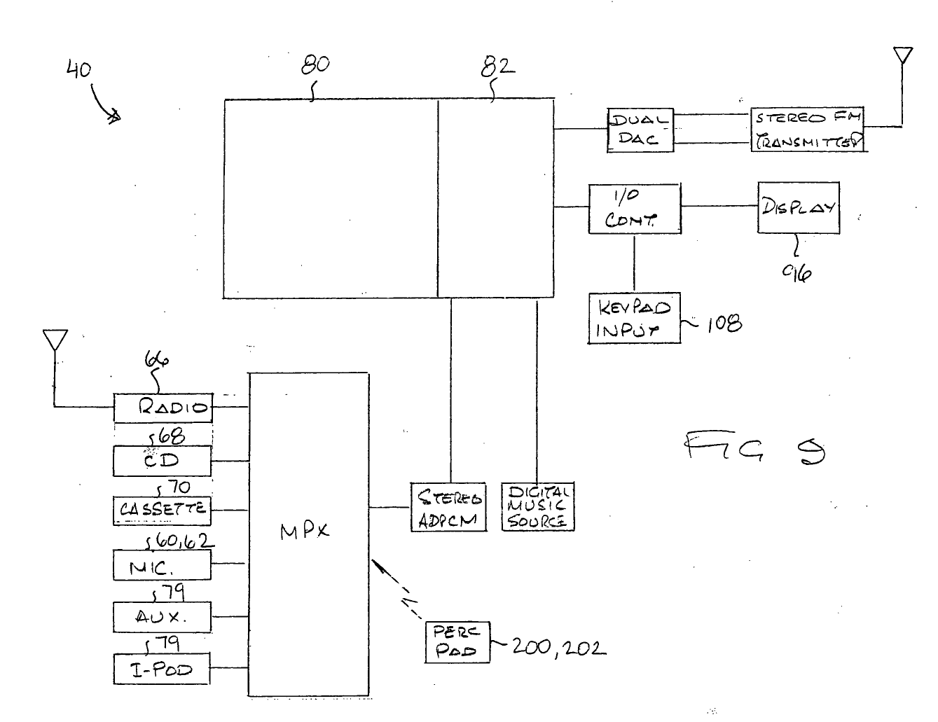

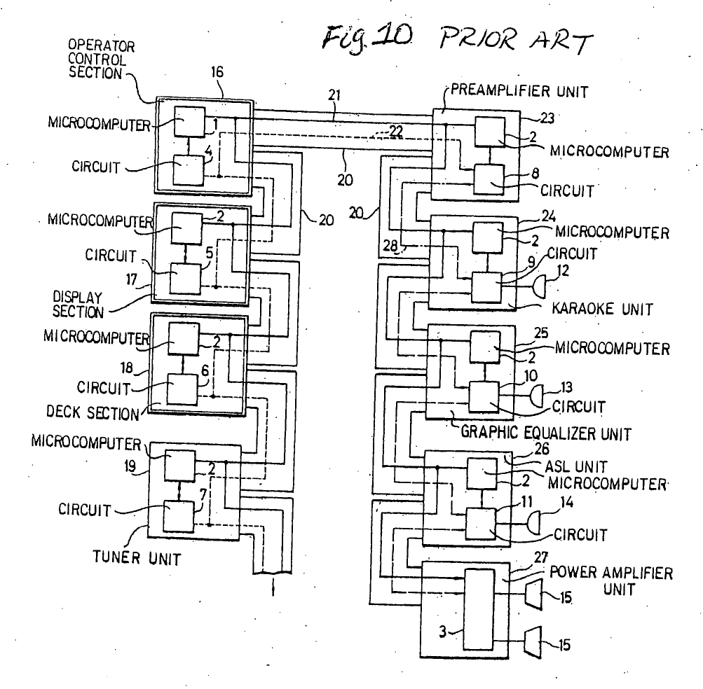

Referring now to the drawings wherein like numerals designate like and corresponding parts throughout the several views, FIG. 10 shows a diagrammatic rendering of a related prior art system, FIGS. 1-9 showing the present invention as will be more fully described below. Specifically, and with reference to FIG. 10, the components shown in double-line enclosures are provided in the console or dashboard unit, which comprises operator control section 16, display section 17, and a deck section 18. The parts shown in single-line enclosures are provided in hideaway locations. The latter include a tuner unit 19, a preamplifier unit 23, a unit 24 for singing along with a tune of a melody recorded on a recording medium such as magnetic tape (hereinafter referred to as “the karaoke unit” or “the karaoke apparatus”), a graphic equalizer unit 25, an ASL unit 26 (an apparatus to control the volume automatically), and a power amplifier unit 27. These components comprise the audio signal processing portion of the system.

The units are connected to one another by a connecting cable 20. The cable 20 is composed of a microcomputer bus line 21 and a two-core shielding connection line 22 which comprises, for example, an L & R channel line and a ground line. Microcomputer 1 and a plurality of microcomputers 2 are respectively connected via the microcomputer bus line 21, wherein the microcomputer 1 works as a master source and each microcomputer 2 works as a terminal satisfying its unit specification. It will be appreciated that additional multichannel music formats including by way of example only, 5.1, 6.1 and 7.1 formats. That is, the terms 5.1, 6.1, and 7.1 mean that there are five, six, or seven main speakers, plus a subwoofer, in the playback system. (A subwoofer reproduces the LFE channel recorded on 5.1 soundtracks, plus any bass the main speakers cannot handle.) The difference in formats is in the number of surround speakers: two in a 5.1 system, three in a 6.1 system, and four in a 7.1 system. An additional format that may be implemented with the present invention includes wall surfaces converted into transducers as will be appreciated by the skilled artisan.

Each of the microcomputers 1 and 2 are connected with the circuits 4 to 11 within the units 16-26. When the circuits 4, 5 of the operator control section and the display section do not have any signal sources, then they would not be connected with the audio bus line 22.

A microphone 12 for the karaoke apparatus is connected with the circuits 9 of the karaoke unit 24. A microphone 13 for detecting so-called pink noise is connected with the circuit 10 of the graphic equalizer 25. Further, a microphone 14 for detecting the running noise is connected with the circuit 11 of the ASL unit 26. In addition, speakers 15 for the L & R channel are connected with the power amplifier units 27. When the operator manipulates the operator controls in this prior art audio equipment, each unit is controlled by the microcomputer 1 and a result of the control state is displayed on the display 17. During operation of deck 18, the audio signal from the circuit 6 is fed to the audio source bus line 22 shown by the dotted line in FIG. 1 and is fed to the circuit 8 of the preamplifier unit 23, wherein signal processing to effect volume control and tone control is performed. The processed signal is fed to the audio signal line 28, which is connected with the power source. Therefore, conventional audio processing is done toward said signal so that finally the speaker 15 is driven through the power amplifier 27.

In the case of the karaoke operation, the audio signal is detected through the microphone 12 connected with the circuit 9 of the karaoke unit 24. This detected signal is subjected to echo processing and mixing and fed to the audio signal line 28. The microphone 13 connected with the graphic equalizer 25 is used for controlling the automatic frequency characteristic and detects pink noise transmitted inside the car. Thus, pink noise originated at the circuit 10 is amplified through the power amplifier and put on the air over the speaker 15 in the car. Owing to the fact that the microphone 13 then detects pink noise, the circuit 10 discriminates the level at each frequency processed by the graphic equalizer and controls the equalizer so as to produce a flat frequency characteristic. Since the microphone 14 of the ASL unit 26 detects the running noise inside the car, the circuit 11 controls the volume and the tone, etc., on the basis of that noise for compensating masking phenomenon which is brought by the running noise. Audio signal system processing of the prior art includes audio outputs of the sources, i.e., the deck section, the tuner unit and other source units, are connected to the audio source bus line as the current source through a voltage-current conversion circuit 29. The signal currents from the plural sources are fed to a current-voltage conversion circuit 30 of the preamplifier 23 to convert the currents into voltage, which are fed to another audio unit through the volume tone circuit 31. Since the car-mounted audio equipment of the prior art is configured as mentioned above, separate microphones have to be provided for the karaoke unit 24, the graphic equalizer unit 25, and the ASL unit 26.

It will be appreciated that the present invention beneficially utilizes this separation of components, in the manner to be more fully described below in connection with the discussion of the preferred embodiments of the present invention.

With reference now to FIGS. 2-9, and according to the present invention, a mobile environment such as an automobile 50 having a dashboard 51 or center console 52 positioned between the commonly-provided two front seats (not shown) of the vehicle 50 may be provided with karaoke operational controls 55 to 59 (FIG. 7), and a vehicle steering wheel 53 to accommodate the overall installation of entertainment system 40. Vocal input is provided via microphones 60, 62 respectively of the entertainment system of the invention, the microphones 60, 62 being mounted where desirable within the confines of the vehicle or even extendable to a location outside of the vehicle such as a pickup-bed or extendable to an extent that enables the vehicle-mounted system to function as part of a sound stage. System controls 55-59 adjust the level of signal output from each of the microphones 60, 62 in the vehicle 50. By way of example, control 55 adjusts the output of the microphone 60. Control 56 adjusts the output of the microphone of the microphone 62. For retrofitted systems, controls 55-59 may be contained in a separate enclosure, and optionally removable to enable vehicle-to-vehicle transfer. To achieve this objective, the bottom (or other portion) of the enclosure may have a removably securable attachment means such as a quick-release bracket or an adhesive strip for attachment to the console or other supporting structure of the vehicle 50.

As indicated above, the entertainment system of the invention is suitable for retrofitting to a vehicle. In the system illustrated, the output from microphones 60, 62 are controlled by variable amplifiers, which in turn are coupled to a first mixer 64, the output of which is coupled to, for example, a feedback or squeal suppressor. A receiving antenna is coupled to radio section having a radio receiver 66, the output of which and the outputs from CD player 68 and cassette player 70 or Bluetooth-enabled output devices 79 (e.g. I-Pod(™)) are coupled to a second mixer 72, the output of which is coupled to transmitter 74 which in turn is coupled to transmitting antenna 74. In operation, the variable amplifiers control the amplitude of the output of the microphones in order to adjust the differences in the singing voices of the occupants of the vehicle. The squeal suppressor and/or audio gate and/or echo cancellation serves to suppress the squeal or echo that would be induced in the system by the proximity of the microphones 60, 62 and the radio receiver 66. Through selection of the output from the radio receiver 66, the CD player 68 or the cassette player 70, mixer 64 mixes the selected output from the various selected input elements with the output from the squeal suppressor and feeds it to the transmitter, which transmits on an FM frequency on the FM dial that is not used for broadcast. The signal from the transmitting antenna is picked up by the receiving antenna of the car stereo radio (not shown), which is tuned to the selected FM frequency. The signal is amplified and coupled to the internal loudspeaker 80 or external loudspeaker 82 and adjusted by the fader and balance controls already present in the stereo system of the vehicle.

According to the invention, percussion inputs are provided via percussion pads 200, 202 operating through an electronic percussion controller, to generate outputs such as but not limited to acoustic and electronic drums, hand percussion instruments, sound effects or any other prerecorded or generated sampled sound. Percussion pads 200, 202 may be obtained from Pintech as Model NR6 Nimrod. As will be appreciated by the skilled artisan, the pads are playable by finger, hand or drum sticks, and outputs are directed via a MIDI, USB, Firewire or other data transmission output for triggering other sound sources, connecting to external sequencer whether contained in a cellular telephone, PDA, laptop computer or outboard musical or electronic device and ultimately being mixed with and outputted with a singer's voice output. As with other inputs, pads 200, 202 may be selectively mapped with different sound outputs to effect a desired sound effect. Pads 200, 202 are either selectively affixed to a desired surface, integrally formed therewith, or provided in an accessory. By way of example, pads 200, 202 with application to a motor vehicle steering wheel 53 may be affixed directed to the rim 206, spokes 208 or center hub 210 of the steering wheel, either removably or permanently. According to one embodiment, pads 200, 202 are mounted to a cross-bar 212 bridging a circumferential aspect of rim 206, either temporarily or permanently secured thereto. For a temporary securement, the cross-bar 212 is secured by one or more (two shown) c-clamp structures for partially embracing the rim 206 with a snap fit engagement, which provides only a nominally additional overall thickness to the steering wheel rim and thus does not hamper rotation of the steering wheel through the driver's hands during typical driving maneuvers.

Alternatively, the pads may be integrally formed with any of those structures, or even provided within the structure of a steering wheel rim cover. According to yet a further embodiment, pads 200, 202 may be incorporated into a partial or full steering wheel cover with fixed or removably secured (e.g. via VELCRO (™) cooperating engagement means) for permanent or temporary affixation as desired. Whatever the securement means, each pad 200, 202 includes a transducer section that transmits to a receiver, and that receiver wirelessly relays output signals to the system controller for desired signal mixing and manipulation prior to sound stream outputting. Accordingly, that wireless link enables application of the pads 200, 202 in its support housing to movable or non-movable surfaces as desired. According to yet a further embodiment of the invention, it is further contemplated that percussion pads 200, 202 may be incorporated into a vehicle structure including but not limited to the dash pad fronting the front passenger seats, or available surfaces in the vehicle's seats or door panels. Signal input in any of those remote locations is by wireless link (by Bluetooth, WiFi or the like transmission link) as will be appreciated by the skilled artisan. Moreover, no matter what location is selected for the percussion pad(s) (one or more, whether mounted to a structural component or to a vehicle control surface such as a steering wheel rim, hub, or spoke), the entirety of each percussion pad and signal transmitter apparatus may be packaged together in that mounting location, such that inputs received by the percussion pads may be transmitted to the designated signal receiver inside or outside the motor vehicle or other installation in which the apparatus is installed.

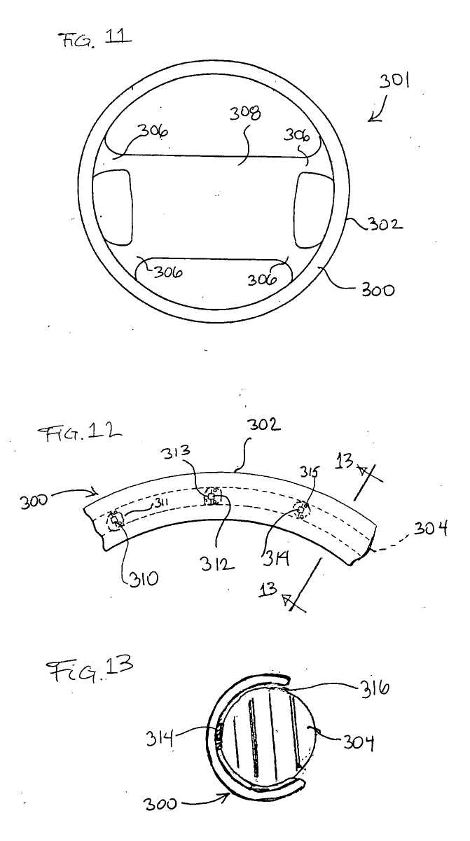

With reference now to FIGS. 11-13, there is illustrated yet another preferred embodiment of the present invention, including a steering wheel cover 300 incorporating some of the operative elements of the above-described invention for installation on a motor vehicle steering wheel 301. The steering wheel cover 300 includes a sleeve 302 configured to substantially encompass a circumferential extent of the rim 304 of the steering wheel 301 in the fully-installed condition, and may optionally wrap to the backside of the steering wheel rim 304 or even be secured in a fully-enveloping or partially-enveloping installation about the steering wheel 301 in the manner known to the art. Furthermore, the cover 300 may further extend to the crossbars 306 or hub 308 of the steering wheel, and in this position serve to accommodate some of the operative elements of the present invention. According to this preferred embodiment, percussion inputs are provided via percussion pads 310, 312, 314 are positioned at an inner surface of the steering wheel cover 300, to be sandwiched between the inner surface of the cover 300 and the steering wheel rim 304. Percussion pads 310, 312, 314 each include transducer sections 311, 313, 315, respectively that transmits to the system receiver in the manner previously described. The cover 300 may be fabricated of leather, vinyl or other materials that can be shaped, stretched or molded to the outer periphery of a steering wheel rim 304, and which can support on the underside thereof one or more percussion pads and transducer sections in a closely-conforming configuration, with good tolerances for operating variations of temperature, humidity, and user handling pressure.

According to one embodiment of the invention, the percussion pads 310, 312, 314 are secured in place in preselected positions about the inner circumference of the cover 300, including but not limited to those hand positions typically adopted by many motor vehicle drivers. This pre-positioning may include circumferential installation positions along an upper circumferential portion of the steering wheel rim 304 facing the driver between the 10 o'clock and 2 o'clock positions, and/or along the relative side portions of the steering wheel rim 304, and/or along the lower circumferential portion of the steering wheel rim 304. Moreover, the percussion pads 310, 312, 314 may be positioned along the crossbars 306 or hub 308 of the steering wheel 301. Percussion pads 310, 312, 314 may be sized and shaped to conform with the generally curved periphery of the steering wheel rim 304, such that the diameter of each percussion pad is about the same as the diameter of the outer periphery of the steering wheel rim 304, and for a percussion pad with a very thin cross-section, providing a substantially smooth, non-stepped visual and surface appearance of the cover 300 according to one embodiment. Alternatively, it may be desired to provide percussion pads with prominent height characteristics to provide a pronounced visual cue to the user as to the actual location of the percussion pads. According to any of the embodiments of the invention, the user/driver of the invention will be able to have immediate access to any or all of the percussion pads as desired, and to enable him to tap/drum on the percussion pads without removing one or both hands from the desired steering wheel handling positions.

Alternatively, it is contemplated that the percussion pads may also be slidably adjustable about the periphery of steering wheel rim 304 within the concavity 316 provided between the steering wheel rim 304 and inner surface of the cover 300 to enable the user to reposition one or more of the percussion pads to suit individual positioning requirements. Optionally, temporary or even permanent adhesive may be applied within concavity 316 as may be required by a particular installation. According to any of the so-selected positions about the circumference of the steering wheel 301, the percussion pads 310, 312, 314 may be configured with the same or different outputs, either as statically designated outputs or programmable outputs via the input controller of the entertainment system 40. Moreover, it is contemplated that the entirety of the so assembled steering wheel 301 and cover 300 with one or more percussion pads may be provided as an-aftermarket replacement unit, that may optionally be configured with a concavity provided within steering wheel hub 308 to receive and retain an air bag restraint system common to most modern motor vehicles. No matter the nature of the installation, sleeved or fully installation, the percussion pads transmit output to a receiver either wirelessly or via a wired connection for data mixing and rebroadcasting in the manner previously described. As noted above, no matter what location is selected for the percussion pad(s) (one or more, whether mounted to a structural component or to a vehicle control surface such as a steering wheel rim, hub, or spoke), the entirety of each percussion pad and signal transmitter apparatus may be packaged together in that mounting location, such that inputs received by the percussion pads may be transmitted to the designated signal receiver inside or outside the motor vehicle or other installation in which the apparatus is installed. It is further contemplated that the entirety of the percussion pads and transmitter circuitry may be miniaturized and optionally prepackaged so as to be readily received and secured to a designated location, or which may be installed in a recess sized and shaped to receive an assembly of the so-noted components, whether in a steering wheel covering or installed as OEM equipment within recesses provided in a designated structure of the steering wheel.

For an off-steering wheel application, a cantilever support 220 is mounted at one end to a suitable support structure of the vehicle 50, the opposite end supporting the pads 200, 202 in the manner previously described, and adjustable via one or more pivot points 222 for the user's convenience. It will be understood that support 220 may be mounted to the dashboard, center console, floor, seat backs, seat frame, or A-, B- or C-pillars of the vehicular structure.

In addition, the basic entertainment of the system may be integrated into the automobile's stereo radio/CD/cassette player. The outputs of microphones are controlled by variable amplifiers, the output of each of which is coupled to the first mixer, the output of which in turn is coupled to the squeal suppresser, which performs the same functions as previously described. The output of the squeal suppresser may then be coupled to additional mixers as necessary and desired. The selected output of the radio, CD player or cassette player is also coupled to the mixers, where the selected signal is mixed with the output from the squeal suppresser. In turn, the mixers are coupled to the output amplifiers, which in turn are coupled to the loudspeakers. The fader controls for the integrated entertainment system of the invention are present on the radio/CD/cassette section of the integrated unit. An input device such as keypad 108 may be utilized for control or labeling purposes.

Further illustrated is a more sophisticated system intended for retrofitting into a vehicle as well as for desktop or non-vehicular data manipulation. Microphones 91 to 95 are respectively coupled to preamplifiers 161 to 165, the outputs of which are respectively coupled to pitch controllers 131 to 135. Pitch controllers and correctors l31 to 135 are intended to counteract any off-key singing. Pitch controllers 131 to 135 in turn are respectively coupled to echo controllers 136 to 140, each of which in turn is coupled to USARTs 151 to 155 respectively. USARTs 151 to 156 are present on microprocessor chip 150, as is ROM 157. Receiving antenna 97 receives radio broadcast frequencies for radio 98. Radio 98, CD 99, cassette 100 and auxiliary 104 are coupled to multiplex 105, which in turn is coupled to stereo ADPCM 106. ADPCM 106 is coupled to USART 156. An alternative coupling to USART 156 for CD 99 is shown by the dotted line. Also coupled to microprocessor 150 is digital music source 166, which may be a hard drive or a memory card, etc. Microprocessor 150 is coupled to dual DAC 148, which in turn is coupled to stereo FM transmitter 102, which broadcasts via antenna 103 to an unused frequency on the FM dial of the radio of the vehicle. The dial is tuned to receive the frequency being broadcast from transmitter 102. Also coupled to microprocessor 150 is input/output controller 167, which receives control input by means of keypad input 168. The status of the system and the input may be viewed on a display 169, which may be an LCD display.

The power source for the systems in may be the vehicle's electrical system, i.e., the vehicle's battery. The systems may be connected to the vehicle's electrical system through the vehicle's cigarette lighter socket. Alternatively, they may be hardwired to the electrical system. The systems may instead be operated from internal batteries. As described above, non-mobile applications, including but not limited to desk-top applications, according to the invention are contemplated as suitable environments for data manipulation in the manner described.

The foregoing specification and drawings have thus described and illustrated a novel entertainment system for a motor vehicle. Many changes, modifications, variations and other uses and applications of the subject invention will, however, become apparent to those skilled in the art after considering this specification, which discloses the preferred embodiments thereof. All such changes, modifications, variations and other uses and applications which do not depart from the spirit and scope of the invention are deemed to be covered by the invention, which is to be limited only by the claims which follow.

What we claim is:

1. In an entertainment system for a motor vehicle comprising a first sound source which produces a first output signal, a second sound source of recorded music which produces a second output signal, a switch coupled to the first sound source and the second sound source for selecting one of said first and second signals and passing said selected signal to a third signal output, at least one loudspeaker and circuit means for connecting said third signal output to said loudspeaker, the improvement comprising at least one percussion input mounted to a control surface of the motor vehicle arranged to be mixed with a separate input and to produce a fourth output signal in response thereto, an electronic mixer circuit being coupled to said connecting means to supply the mixed signal to the loudspeaker.

2. An entertainment system as claimed in claim 1, wherein there are at least two input transceivers present in the system, each arranged to receive the voice of a different occupant of the vehicle.

3. An entertainment system as claimed in claim 2, wherein the electronic signal output from each transceiver is coupled to said mixer circuit.

4. An entertainment system as claimed in claim 1, wherein the percussion input is mounted to a steering wheel of the vehicle.

5. An entertainment system as claimed in claim 4, wherein the percussion input is mounted immediately adjacent the rim of the steering wheel.

6. An entertainment system as claimed in claim 4, wherein the percussion input is mounted on a spoke of the steering wheel.

7. An entertainment system as claimed in claim 4, wherein the percussion input is mounted on a hub of the steering wheel.

8. An entertainment system as claimed in claim 1, further comprising a steering wheel cover for encompassing at least a circumferential portion of the steering wheel, supporting said at least one percussion input.

9. An entertainment system as claimed in claim 8, further comprising a plurality of percussion inputs.

10. An entertainment system as claimed in claim 8, wherein the steering wheel cover is removably secured to the steering wheel.

11. An entertainment system as claimed in claim 8, wherein at least one of said percussion inputs is selectively positionable.

12. In an entertainment system comprising a sound-generating communication device which produces a first output signal, a source of recorded music which produces a second output signal, a switch coupled to the communication device and the recorded music source for selecting one of said first and second signals and passing said one signal to a third signal output, at least one loudspeaker and circuit means for connecting said third signal output to said loudspeaker, the improvement comprising at least one percussion input arranged to be mixed and to produce a third output signal in response thereto, an electronic mixer circuit being coupled to said connecting means to supply the mixed signal to the loudspeaker.

13. An entertainment system as claimed in claim 12, wherein the communications device is a radio.

14. An entertainment system as claimed in claim 12, wherein the transceiver is a percussion input device.

15. An improvement for use in connection with an audio system operatively in a mobile environment, the audio system including a sound generator, at least one loudspeaker and circuit means for connecting output from the sound generator thereto, the improvement comprising a percussion input transceiver arranged to be mixed with output from the sound generator for supplying the mixed signal to the loudspeaker.

16. The input device as recited in claim 15, wherein the control surface is a steering wheel of the vehicle.

17. The input device as recited in claim 15, wherein the sound generator is selected from the group including a radio receiver, a pre-recorded media player, and live vocal input.

18. The input device as recited in claim 15, wherein the input device is operatively linked with the audio system by wireless link.

19. The input device as recited in claim 22, wherein the mobile environment is selected from the group including vehicles designated to travel by land, sea and air.
